(19) United States
(12) Patent Application Publication
(10) Pub. No.: US 2025/0108734 A1
(43) Pub. Date: Apr. 3, 2025

(54) SEAT, IN PARTICULAR VEHICLE SEAT

(71) Applicant: Adient US LLC, Plymouth, MI (US)

(72) Inventors: Pradeep KONJIWALE, Pune (IN); Umesh DESHPANDE, Pune (IN); Supriya MOON, Pune (IN)

(21) Appl. No.: 18/901,483

(22) Filed: Sep. 30, 2024

(30) Foreign Application Priority Data
Oct. 2, 2023 (DE) 102023209659.5

(51) Int. Cl. B60N 2/20

(52) U.S. Cl. CPC B60N 2/20

(57) ABSTRACT

A vehicle seat may have a seat support structure that may have at least a fixed base element, a seat pan and a backrest, which are adjustable relative to the base element. The seat support structure may also have a reclining mechanism which is designed to move the seat support structure between an upright seat position and at least a horizontal bed position. The reclining mechanism may have a first linkage mechanism with which the seat pan is coupled to the base element, and a second linkage mechanism with which the backrest is coupled to the base element. The two linkage mechanisms are or have been maintained in an uncoupled state relative to one another in the upright seat position, and when the reclining mechanism is actuated, adopt a coupled state to transfer the seat support structure into the horizontal bed position.

### FIELD

The invention relates to a seat, in particular a vehicle seat, which comprises at least a seat support structure and a reclining mechanism which is designed to move the seat support structure between an upright seat position and at least a horizontal bed position.

### BACKGROUND

A wide range of adjustable, in particular reclinable seats, such as transport vehicle seats or aircraft passenger seats, are known from the prior art. A vehicle seat comprises, for example, at least a seat pan and a backrest, wherein the backrest is pivotably coupled to the seat pan. The backrest may be coupled to the seat pan via a driven reclining mechanism. Furthermore, the vehicle seat may comprise a rail assembly for adjusting the vehicle seat in a longitudinal direction.

### SUMMARY

An aim of the present disclosure is to provide an improved seat, in particular a vehicle seat, which is easily adjustable between at least an upright starting seat position, such as a boarding/disembarking and seat position, and at least a horizontal bed position in which the seat pan and the backrest form an extended lying surface. In particular, an aim of the present disclosure is to provide a robust, less complex and user-friendly seat which comprises a reclining mechanism that is designed to transfer the seat extremely comfortably through an entire seat-adjustment range of movement.

Preferred embodiments of the invention can be found in the dependent claims.

To achieve the above aims, the present invention features a seat, in particular a vehicle seat, which comprises at least a seat support structure which comprises at least a fixed base element, a seat pan and a backrest, which are adjustable relative to the base element, and a reclining mechanism which is designed to move the seat support structure between an upright seat position and at least a horizontal bed position. The reclining mechanism comprises a first linkage mechanism with which the seat pan is coupled to the base element, and a second linkage mechanism with which the backrest is coupled to the base element, wherein the two linkage mechanisms are maintained in an uncoupled state relative to one another in the upright seat position, and when the reclining mechanism is actuated, adopt a coupled state in order to transfer the seat support structure into the horizontal bed position.

The advantages achieved by the invention reside in a uniform and smooth seat adjustment movement while the seat support structure, i.e. the seat pan and the backrest, is being transferred from the upright seat position into the horizontal bed position. The linkage mechanisms can pass into the coupled state in order to carry out a combined movement, in particular an adjustment movement. In one possible embodiment, fewer drive units such as motor units for actuating the linkage mechanisms are thus required.

On account of the large number of adjustment options, seat support structures, for example subframes, are frequently very complicated, but this results in high material consumption and high production costs for such seats.

The seat according to the invention includes two linkage mechanisms, which are maintained in an uncoupled state relative to one another in the upright seat position and, when the reclining mechanism is actuated, adopt a coupled state in order to transfer the seat support structure into the horizontal bed position, wherein the seat can be designed in a substantially compact manner, with a lower weight and in an optimized manner in terms of components.

The reclining mechanism may comprise only one drive unit coupled to one of the linkage mechanisms, wherein the linkage mechanisms are moved by drive-actuation of one of the linkage mechanisms such that it couples with the other of the linkage mechanisms in order to carry out a combined movement, in particular a reclining movement. It goes without saying that, for the reclining mechanism, more than one drive unit can be used, although this can be avoided.

In the case of a manually actuable reclining mechanism, the reclining mechanism can be actuated by one-handed actuation in order to rotate the seat support structure between the upright seat position and the horizontal bed position. The invention provides improved seat adjustment functionality. The reclining mechanism contributes to raising the seat pan such as a seat cushion, while the backrest is reclined at the same time. The user can, for example, push or pull the backrest, i.e. the user can manually actuate the second linkage mechanism in order to achieve a combined adjustment movement of the seat pan and the backrest from the upright seat position into the horizontal bed position and vice versa. The reclining mechanism is configured such that the returning of the seat support structure from the horizontal bed position into the upright seat position can also be embodied as a combined adjustment movement, which is driven, for example, by the drive unit and/or by one-handed actuation.

The linkage mechanisms may be designed, in the coupled state, to move the seat pan and the backrest at the same time. The seat pan and the backrest can carry out an adjustment movement between an upright seat position, at least one reclined intermediate position and a horizontal bed position in a comfortable and uniform manner.

The upright seat position may be the starting position, in which the backrest can be arranged substantially perpendicularly with respect to the seat pan. An axis passing through the backrest may be arranged, for example, at an angle of approximately 3° to 17° to a vertical axis. The reclined intermediate position may be a comfort position, in which the backrest can be arranged in a more reclined position with respect to the seat surface. The axis passing through the backrest may be arranged, for example, at an angle of approximately 17° to less than 80° to the vertical axis. The horizontal bed position may be a sleeping or lying position, in which the backrest forms a substantially horizontal plane with the seat surface. The axis passing through the backrest may, in this case, be arranged at an angle of approximately 85° to 90° to a vertical axis. The axis passing through the backrest may, in particular, be arranged substantially parallel to a horizontal axis and form a horizontal lying plane with the seat pan.

The linkage mechanisms may be designed, in the coupled state, to raise the seat pan about a first horizontal pivot axis and to recline the backrest about a second horizontal pivot axis. The first horizontal pivot axis may be different from the second horizontal pivot axis.

The first horizontal pivot axis of the seat pan may be defined by a fixed rotary joint which is arranged in a front portion of the seat pan. The front fixed rotary joint may be coupled to the base element and/or may be arranged on the base element. The second horizontal pivot axis of the backrest may be defined by a fixed rotary joint which may be arranged on and/or coupled to the base element for example in the region of a crossbar and/or fitting device, for example of a common reclining system. The fixed rotary joint pertains to a fixed position on the base element.

The reclining mechanism may be designed such that the coupled state of the linkage mechanisms is achieved by actuation, such as manual actuation and/or motor-driven actuation, of the second linkage mechanism relative to the base element.

A drive unit may be coupled to the fixed rotary joint of the backrest and/or to the crossbar and/or the fitting device. As a result of the fixed rotary joint being rotated, the second linkage mechanism can be pivoted about the fixed rotary joint, which defines a horizontal pivot axis. The backrest may, as an alternative or optionally, additionally comprise an actuating element such as an actuating lever which the user can pull to actuate the movement of the second linkage mechanism.

The linkage mechanisms may comprise coupling elements which are spaced apart from one another at linkage ends of the linkage mechanisms and in the uncoupled state and come into engagement with one another in the coupled state. The coupling elements may be configured as corresponding latching elements, clip elements, protruding lugs and recesses which may come into releasable engagement with one another.

For example, the linkage mechanisms are separated from one another in the uncoupled state. In particular, the linkage mechanisms are completely mechanically uncoupled from one another in the uncoupled state. In other words: the linkage mechanisms are uncoupled from one another in an unguided manner.

The first linkage mechanism may comprise at least one first coupling element which is guided movably in a guide element which is arranged on the fixed base element. The second linkage mechanism may comprise at least one second coupling element having a receiving portion which comes into contact, in particular engagement, with the first coupling element in the coupled state. Furthermore, the second linkage mechanism may comprise a third coupling element having a receiving portion which comes into contact, in particular engagement, with the first coupling element in the coupled state.

The contact or engagement of the second coupling element with the first coupling element may, for example upon actuation, in particular movement, of the second linkage mechanism from the upright seat position and/or the reclined intermediate position into the horizontal bed position, initiate a movement of the first linkage mechanism. The contact or engagement of the third coupling element with the first coupling element may, for example upon actuation, in particular movement, of the second linkage mechanism from the horizontal bed position into the reclined intermediate position and/or the upright seat position, initiate a movement of the first linkage mechanism.

The reclining mechanism may be designed to transfer the seat support structure from one position into another by shifting the first coupling element along the guide element by moving the second coupling element and optionally additionally the third coupling element.

The reclining mechanism may comprise, between the linkage mechanisms, a free running region by virtue of which the backrest can be reclined from the upright seat position into a reclined intermediate position before the linkage mechanisms pass into the coupled state in order to transfer the seat support structure into the horizontal bed position. The free running region may be a predefined spacing between the second coupling element and optionally additionally the third coupling element of the second linkage mechanism and the first coupling element of the first linkage mechanism.

At a degree of reclining of the backrest of approximately 65 to 80, for example approximately 78°, the coupling elements of the two linkage mechanisms, for example, come into contact, in particular engagement, with the result that the backrest and the seat pan are levelled out on a sleeping or lying bed surface, in particular the horizontal bed position. This means that the backrest can be reclined by up to 65° to 80° without a combined movement of the seat pan, in order to take up a reclined intermediate position, in particular a reclined comfort position. The seat pan may remain in its original upright seat position. A further movement of the backrest towards its horizontal bed position causes the linkage mechanisms to come into contact with one another such that the seat pan is raised by the movement of the backrest, in order to take up the horizontal bed position.

The first linkage mechanism may comprise two fixed rotary joints between which a first number of relatively pivotable linkage members are arranged, wherein the fixed rotary joints couple the seat pan to the base element.

The second linkage mechanism may comprise a fixed rotary joint which couples the backrest to the base element, and a second number of pivotable linkage members which are pivotable about the fixed rotary joint.

The linkage members may be linkage bars or rods or the like. The first linkage mechanism may be arranged in a rear side of the seat pan.

The further scope of applicability of the present invention and also advantageous embodiments, which can be used individually or in combination with one another, will become apparent from the following detailed description. It goes without saying, however, that although the detailed description and specific examples indicate preferred embodiments of the invention, they serve only for illustration, since various alterations and modifications within the spirit and scope of application of the invention will be obvious to those skilled in the art from this detailed description.

### DESCRIPTION OF THE FIGURES

The present invention will be understood better from the following description and the accompanying drawings, which serve merely for illustration and do not restrict the present invention. In the drawings:

FIG. 1: shows a seat, in particular a vehicle seat, from the prior art,

FIG. 2: shows a seat according to a first embodiment, which comprises a seat support structure and a reclining mechanism in order to move the seat support structure between an upright seat position and at least a horizontal bed position,

FIG. 3: shows the seat according to FIG. 2 in a reclined intermediate position,

FIG. 4: shows the seat according to FIG. 3 in the horizontal bed position,

FIG. 5: shows a reclining mechanism according to a second embodiment, which comprises two linkage mechanisms which are in an uncoupled state in an upright seat position of the seat,

FIG. 6: shows possible movement sequences of the reclining mechanism according to FIG. 5,

FIG. 7: shows the reclining mechanism according to FIG. 5 in an upright seat position,

FIG. 8: shows the reclining mechanism according to FIG. 5 in a reclined intermediate position, and

FIG. 9: shows the reclining mechanism according to FIG. 5, in a horizontal bed position.

### DETAILED DESCRIPTION

Corresponding parts are identified by the same reference symbols in all the figures.

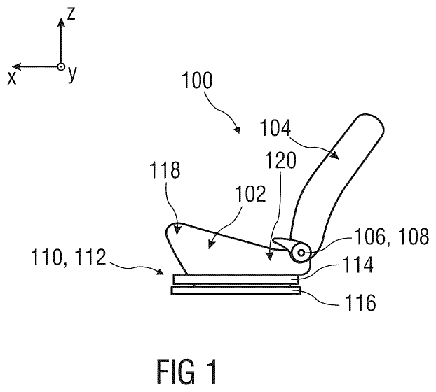

A prior art vehicle seat 100 shown schematically in FIG. 1 is described below using three spatial axes or directions which extend perpendicularly to one another. A longitudinal axis x extends horizontally and preferably parallel to a longitudinal direction of a vehicle having a vehicle seat 100 installed in the vehicle. The longitudinal direction corresponds to the usual direction of travel of the vehicle. A transverse axis y is likewise oriented horizontally in the vehicle and extends perpendicularly to the longitudinal direction and parallel to a transverse direction of the vehicle. A vertical axis z extends perpendicularly to the longitudinal direction and perpendicularly to the transverse direction. In the case of a vehicle seat 100 installed in the vehicle, the vertical axis z extends preferably parallel to a vehicle vertical direction.

The position and direction indications that are used, such as front, rear, upper and lower, relate to a viewing direction of an occupant sitting in an upright seat position 150 such as in a normal seat position on the vehicle seat 100, wherein the vehicle seat 100 is installed in the vehicle in a use position suitable for passenger transport with an upright backrest 104, wherein the vehicle seat 100 is oriented as customary in the direction of travel. The vehicle seat 100 can, however, also be installed or moved in an orientation that differs therefrom, for example transversely to the direction of travel. Unless described otherwise, the vehicle seat 100 is constructed mirror-symmetrically with respect to a plane extending perpendicularly to the transverse direction y.

The backrest 104 may be arranged pivotably on a seat pan 102 of the vehicle seat 100. To this end, the vehicle seat 100 may optionally comprise a fitting device 106, in particular an adjustment fitting, a pivot fitting, a latching fitting or a wobble fitting.

The position and direction indications that are used, such as radial, axial and circumferential, relate to an axis of rotation 108 of the fitting device 106. Radial means perpendicular to the axis of rotation 108; axial means in the direction of the axis of rotation 108 or parallel thereto.

The vehicle seat 100 may optionally comprise a longitudinal adjustment device 110. The longitudinal adjustment device 110 has for example a rail assembly 112 with a first rail element 114 and a second rail element 116.

The first rail element 114 is adjustable in a longitudinal direction with respect to the second rail element 116. The first rail element 114 is attached to the seat pan 102. The second rail element 116 is attached to a structural element of a vehicle, for example to a vehicle floor.

For reasons of clarity, the first rail element 114 is referred to as the upper rail 114 in the following description. This upper rail 114 (also referred to as slide rail or slide) is assigned to the vehicle seat 100 and is designed to support the vehicle seat 100. The second rail element 116 is furthermore referred to as the lower rail 116. The lower rail 116 is fixed in position and is connected for example to the floor of a vehicle.

The known vehicle seat 100 having the fitting device 106 is designed such that the fitting device 106, in particular the axis of rotation 108 thereof, the seat pan 102 and the backrest 104 are coupled to one another. The backrest 104 may be pivotable about the axis of rotation 108. The seat pan 102 may be stationary with respect to the axis of rotation 108.

Furthermore, the commonly known stationary seat pan 102 comprises a front portion 118, for example a cushioned front portion, which is raised and/or protrudes with respect to a horizontal central surface of the seat pan 102. Such a front portion 118 may form a thigh support, in particular a front cushion and/or a side cushion. Alternatively or additionally, the front portion 118 of the seat pan 102, which supports the thighs of a passenger, may be arranged in a raised and/or angled manner with respect to a lower rear portion 120, which supports for example the buttocks of the passenger.

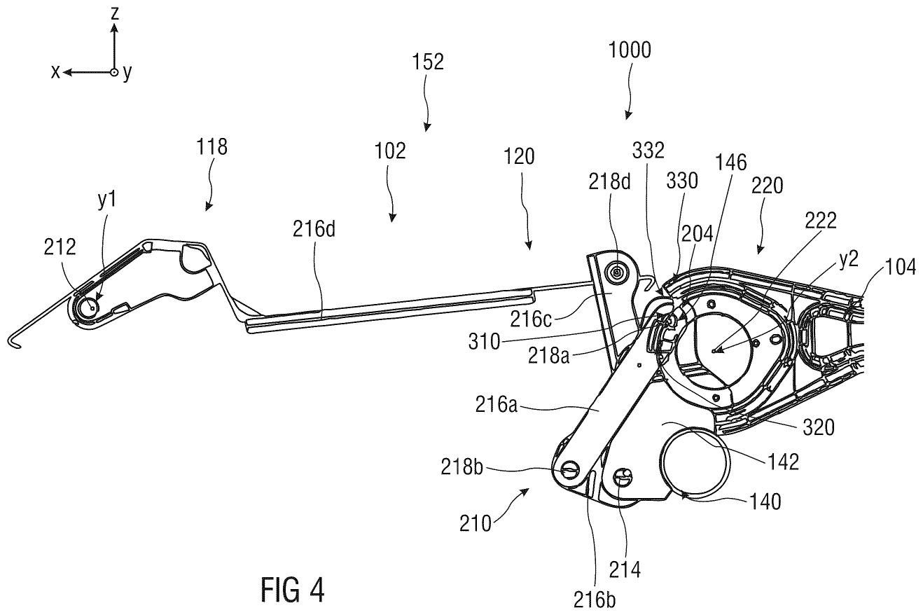

In order to provide greater comfort for the passenger, it is desirable to provide a seat 1000 as described below, which can take up a horizontal bed position 152, in which the seat pan 102 and the backrest 104 can form a substantially horizontal lying or sleeping surface, as shown in FIGS. 4, 6 and 9. For more comfort, it is desirable to provide a movable, for example pivotable, in particular raisable, seat pan 102. It is in particular desirable to provide a movable, for example pivotable, in particular raisable rear portion 120 of the seat pan 102, while a thigh supporting function of the front portion 118 is maintained when the seat 1000 is arranged in the upright seat position 150.

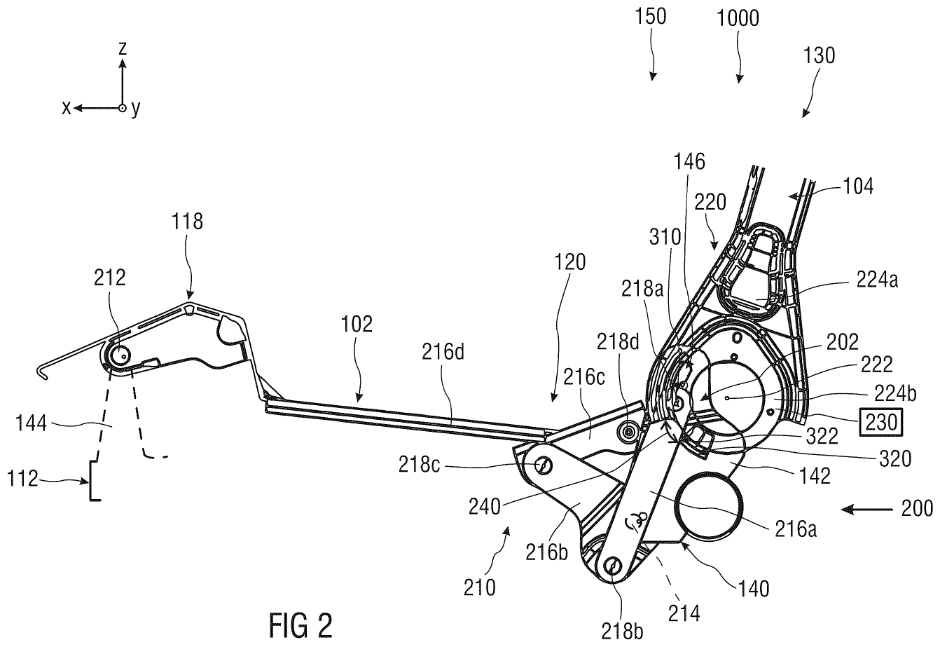

FIG. 2 shows a seat 1000 according to a first embodiment, which comprises a seat support structure 130 and a reclining mechanism 200 in order to move the seat support structure 130 between an upright seat position 150 and at least a horizontal bed position 152.

The seat support structure 130 comprises the backrest 104 and the seat pan 102. The seat support structure 130 may be a seat frame structure. The seat support structure 130 may comprise a backrest frame which carries a cushioning that forms a cushioned backrest 104. The seat support structure 130 may comprise a seat pan frame which carries a cushioning that forms a cushioned seat pan 102.

Furthermore, the seat support structure 130 comprises a fixed base element 140. The fixed base element 140 may be a base structure which, for example, supports the seat support structure 130 on the vehicle floor, a vehicle structure and/or on the rail assembly 112 or couples it thereto. The fixed base element 140 may be a frame structure. The fixed base frame 140 may comprise a fixed rear base portion 142. The fixed base frame 140 may comprise a fixed front base portion 144. The fixed base portions 142, 144 may be vertically extending frame elements which connect the seat pan 102 to the vehicle floor, a vehicle structure and/or the rail assembly 112, in particular to the movable first rail element 114. The base portions 142, 144 may be coupled together via a horizontally extending base portion and/or a frame element, which are not shown in more detail.

The reclining mechanism 200 comprises a first linkage mechanism 210, which couples the seat pan 102 to the base element 140, and a second linkage mechanism 220, which couples the backrest 104 to the base element 140, wherein the two linkage mechanisms 210, 220 are maintained in an uncoupled state 202 relative to one another in the upright seat position 150.

Upon actuation of the linkage mechanisms 210, 220, i.e. of the first linkage mechanism 210 or of the second linkage mechanism 220, the actuated linkage mechanism 210, 220 can be moved continuously from the upright seat position 150 into the horizontal bed position 152. On a path along a predetermined adjustment course, for example at an adjustment angle, the linkage mechanisms 210, 220 can remain in the uncoupled state 202 such that the backrest 104 can be reclined from the upright seat position 150 into at least one reclined intermediate position 154 with no effect on a position of the seat pan 102.

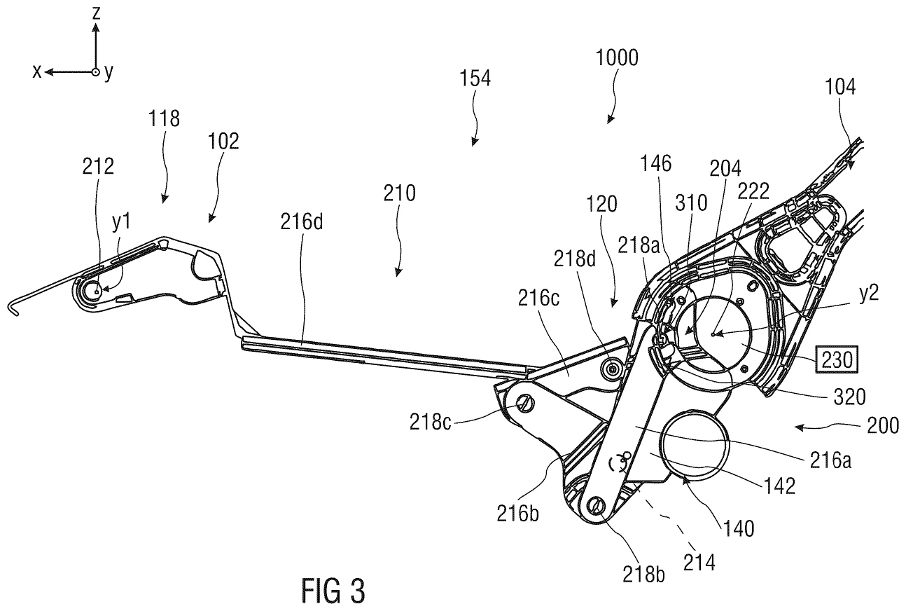

In the reclined intermediate position 154, which is shown in FIGS. 3, 6 and 8, it is possible, for example, for the linkage mechanisms 210, 220 to adopt a coupled state 204. In the coupled state 204, the two linkage mechanisms 210, 220 are coupled together, i.e. to one another, such that a further actuation, i.e. movement of the same linkage mechanism 210, 220 as was previously actuated results in the implementation of a joint or combined movement of the two linkage mechanisms 210, 220 into the horizontal bed position 152. The actuation can be motor-driven and/or manual.

Thus, it may suffice to provide the reclining mechanism 200 with a single drive unit 230 or a single actuator in order to adjust the seat support structure 130 from its upright seat position 150 into the horizontal bed position 152 and vice versa as per arrow 231. To successfully recline the seat support structure 130, it may furthermore suffice to manually actuate the seat pan 102 or the backrest 104, for example to move, pull or push same, in order to fully adjust the seat support structure 130 from its upright seat position 150 into the horizontal bed position 152 and vice versa as per arrow 231.

The first linkage mechanism 210 may comprise a first fixed rotary joint 212, which is fastened to the base element 140 in the region of the front base portion 144. The first linkage mechanism 210 may comprise a second fixed rotary joint 214, which is fastened to the base element 140 in the region of the rear base portion 142. In FIGS. 4 to 9, the second fixed rotary joint 214 is shown in an uncovered manner. The first linkage mechanism 210 may comprise a first number of relatively pivotable linkage members 216a to 216d, which are also referred to as bars and which are arranged between the fixed rotary joints 212, 214. The linkage members 216a to 216d are coupled together via a number of rotary joints 218a to 218d. The first linkage mechanism 210 may be a so-called multimember linkage such as a four-member linkage, a five-member linkage or a six-member linkage. In the embodiment, the first linkage mechanism 210 is in the form of a four-member linkage. The second linkage mechanism 220 is in the form of a single linkage arm or of a single linkage lever.

A first linkage member 216a is coupled movably to the base element 140 via a first rotary joint 218a, in particular in the region of the rear base portion 142. A second linkage member 216b is coupled pivotably to the first linkage member 216a via a second rotary joint 218b. The second linkage member 216b may be a linkage plate, which is, for example, substantially L-shaped and is designed to couple the linkage members 216a to 216d pivotably to the second fixed rotary joint 214. A third linkage member 216c is pivotably coupled to the second linkage member 216b and a fourth linkage member 216d. The third linkage member 216c is coupled to the second linkage member 216b via a third rotary joint 218c. The fourth linkage member 216d couples the linkage members 216a to 216d to the first fixed rotary joint 212. The fourth linkage member 216d is coupled to the third linkage member 216c via a fourth rotary joint 218d.

The second linkage mechanism 220 may comprise a fixed rotary joint 222, which is fastened to the base element 140 in the region of the rear base portion 142. The fixed rotary joint 222 may be provided by a known crossbar (not shown in more detail), which couples two structural sides, for example frame sides, of the seat support structure 130. The second linkage mechanism 220 may comprise a second number of pivotable linkage members 224a, 224b which are pivotable about the fixed rotary joint 222. In the embodiment shown, the second linkage mechanism 220 comprises a first linkage member 224a, which defines a backrest surface. The second linkage mechanism 220 comprises a second linkage member 224b, which is coupled to a lower side of the first linkage member 224a. The linkage members 224a, 224b may be in the form of a single part which is in the form of a backrest frame and/or of a backrest fitting part.

The linkage mechanisms 210, 220 comprise corresponding coupling elements 310, 320, which are spaced apart from one another in the uncoupled state 202 and come into engagement with one another in the coupled state 204. The first rotary joint 218a of the first linkage mechanism 210 may form a first coupling element 310. The first coupling element 310 may be a pin protruding in a transverse direction. The second linkage mechanism 220 may comprise a second coupling element 320. The second coupling element 320 may be arranged on an opposite, in particular lower, side of the backrest 104. The second coupling element 320 may be arranged fixedly on one of the linkage members 224a, 224b. In the second embodiment, the second coupling element 320 is arranged on the second linkage member 224b and is in the form of a protruding lug or nose. The second coupling element 320 may protrude radially with respect to the fixed rotary joint 222. The linkage members 224a, 224b are fastened to one another.

The base element 140, in particular the rear base portion 142, may comprise a guide element 146. The guide element 146 may be provided on an upper side of the base element 140, in particular of the rear base portion 142. The guide element 146 may have a bent or curved shape. The guide element 146 may be bent or curved such that a midpoint of the bend or curve can be arranged coaxially with the fixed rotary joint 222.

The first coupling element 310, in particular the first rotary joint 218a, is guided movably in the guide element 146, which is arranged on the fixed base element 140. The guide element 146 may be a slot, in particular an elongated hole, which forms a sliding fixation for the first coupling element 310. The second coupling element 320 may comprise a receiving portion 322, which comes into engagement with the first coupling element 310 in the coupled state. The reclining mechanism 200 is designed to transfer the seat pan 102 and the backrest 104 from one position 150 to another 154 in that the first coupling element 310 is shifted along the guide element 146 by means of movement of the second coupling element 320 when the coupling elements 310, 320 are in the coupled state 204.

The reclining mechanism 200 may comprise a free running region 240 between the first coupling element 310 and the second coupling element 320, such that the backrest 104 can be reclined from the upright seat position 150 into a reclined intermediate position 154 before the coupling elements 310, 320 come into engagement in the coupled state 204 in order to transfer the seat pan 102 and the backrest 104 into the horizontal bed position 152. The free running region 240 may define a spacing between the first coupling element 310 and the second coupling element 320, in which the two coupling elements 310, 320 may be in the uncoupled state 202.

FIG. 3 shows the seat 1000 according to FIG. 2 in a reclined intermediate position 154.

The reclining mechanism 200 is designed such that the coupled state 204 of the linkage mechanisms 210, 220 is achieved by actuation, such as manual actuation and/or motor-driven actuation, of the second linkage mechanism 220 with respect to the base element 140. The second linkage mechanism 220 may be coupled to the drive unit 230. The drive unit 230 may be a reclining drive or actuator. The drive unit 230 may be coupled to the fixed rotary joint 222 in order to pivot the linkage members 224a, 224b. As a result of rotation of the fixed rotary joint 222, for example of a backrest fitting or of a fitting bar and/or the linkage members 224a, 224b, the second linkage mechanism can be pivoted about the fixed rotary joint 222, which defines a second horizontal pivot axis y2, which extends for example parallel to the transverse axis y.

The linkage mechanisms 210, 220 are designed, in the coupled state 204, to raise the seat pan 102 about a first horizontal pivot axis y1, which extends for example parallel to the transverse axis y.

FIG. 4 shows the seat 1000 according to FIG. 3 in the horizontal bed position 152.

The linkage mechanisms 210, 220 are designed in particular to raise the seat pan 102 by raising the third and the fourth linkage member 216c, 216d, as shown in FIG. 4. As a result, the rear portion 120 of the seat pan 102 can be raised in a continuous movement, while a thigh supporting function of the front portion 118 of the seat pan 102 is maintained. The fixed rotary joints 212, 214 of the first linkage mechanism 210 are spaced apart from one another in a vertical direction and in the longitudinal direction. The first to third linkage members 216a to 216c are arranged under the rear portion 120 of the seat pan 102. The linkage members 216a to 216d are pivoted with respect to one another between two fixed rotary joints 212, 214 such that both the rear portion 120 and a seat surface provided between the rear portion 120 and the front portion 118 of the seat pan 102 are raised with respect to the first horizontal pivot axis y1.

In order to move the seat support structure 130 back from the horizontal bed position 152 into the upright seat position 150 or into the reclined intermediate position 154, the second linkage mechanism 220 may comprise a third coupling element 330, which has a receiving portion 332 which comes into contact, in particular engagement, with the first coupling element 310, i.e. with the first linkage mechanism 210, during a return movement. The reclining mechanism 200 is designed to transfer the seat pan 102 and the backrest 104 from the horizontal bed position 152 into the reclined intermediate position 154 and/or the upright seat position by shifting the first coupling element 310 along the guide element 146 by moving the third coupling element 330.

Alternatively or optionally additionally, the first linkage mechanism 210 may be under a spring preload such that the first coupling element 310 and thus the first linkage mechanism 210 follows the return movement by spring force when the second coupling element 320 is moved away from the first coupling element 310. The third coupling element 330 is possibly not required.

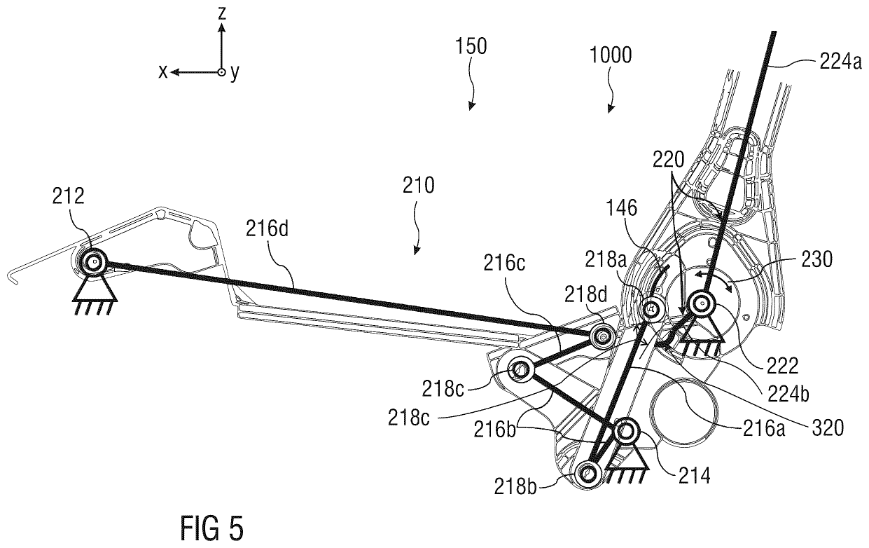

FIG. 5 shows a reclining mechanism 200 according to a second embodiment, which comprises two linkage mechanisms 210, 220, which are in an uncoupled state 202 in an upright seat position 150 of the seat 1000.

The reclining mechanism 200 comprises a first linkage mechanism 210, which couples the seat pan 102 to the base element 140, and a second linkage mechanism 220, which couples the backrest 104 to the base element 140, wherein the two linkage mechanisms 210, 220 are maintained in an uncoupled state 202 relative to one another in the upright seat position 150. Upon actuation of one of the linkage mechanisms 210, 220, i.e. of the first linkage mechanism 210 or of the second linkage mechanism 220, the actuated linkage mechanism 210, 220 can be moved at the same time from the upright seat position 150 into the horizontal bed position 152.

The first linkage mechanism 210 may be a so-called multimember linkage, such as a four-member linkage, a five-member linkage or a six-member linkage.

The second linkage mechanism 220 may comprise a fixed rotary joint 222, which is fastened to the base element 140 in the region of the rear base portion 142. In the embodiment shown, the second linkage mechanism 220 comprises a first linkage member 224a, which defines a backrest surface.

The second linkage mechanism 220 comprises a second linkage member 224b, which is coupled to a lower side of the first linkage member 224a. The linkage members 224a, 224b may be in the form of a single part, which is in the form of a backrest frame and/or of a backrest fitting part. The linkage mechanisms 210, 220 comprise corresponding coupling elements 310, 320, which are spaced apart from one another in the uncoupled state 202 and come into engagement in the coupled state 204.

The first rotary joint 218a of the first linkage mechanism 210 may form a first coupling element 310. The first coupling element 310 may be a pin protruding in a transverse direction. The second linkage mechanism 220 may comprise a second coupling element 320. The second coupling element 320 may be arranged fixedly on one of the linkage members 224a, 224b. In the embodiment shown, the second coupling element 320 is arranged on the second linkage member 224b and is in the form of a receptacle. The second coupling element 320 may be a recess formed in the second linkage member 224b. The second linkage member 224b protrudes from the fixed rotary joint 222. The linkage members 224a, 224b are fastened to one another.

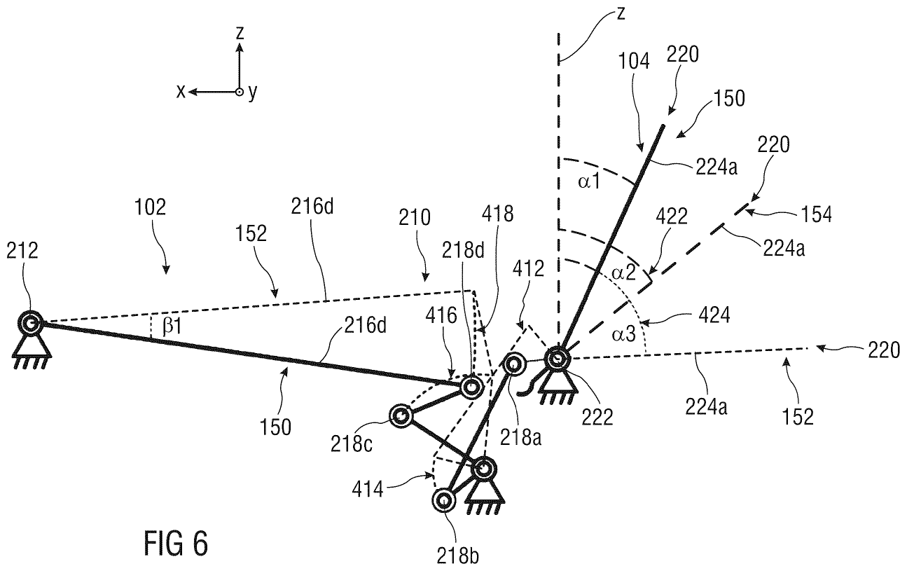

FIG. 6 shows possible movement sequences of the reclining mechanism 200 according to FIG. 5.

The upright seat position 150 may be the starting position, in which the backrest 104 can be arranged substantially perpendicularly to the seat pan 102. The first linkage member 224a may be arranged, for example, at a first angle α1 of approximately 3° to 17° (more or less) to the vertical axis z. The reclined intermediate position 154 may be comfort position, in which the backrest 104 can be arranged in a more reclined position with respect to the seat pan 102. The first linkage member 224a may be arranged, for example, at a second angle α2 of approximately 17° to less than 80° to the vertical axis z. The horizontal bed position 152 may be a sleeping or lying position, in which the backrest 104 forms a substantially horizontal plane with the seat pan 102. In this case, the first linkage member 224a may be arranged at a third angle α3 of approximately 85° to 90° to the vertical axis z. In the upright seat position 150, the seat pan 102 can be arranged substantially parallel to a vehicle floor. The seat pan 102 can be pivoted between an angle β1 of approximately 5° to 20° about the first fixed rotary joint 212 from the upright seat position 150 into the horizontal bed position 152. It goes without saying that the angular ranges are intended to serve merely for better understanding, but are not restricted thereto.

Furthermore, movement paths 412 to 418 of the linkage members 216a to 216d and/or of the rotary joints 218a to 218d of the first linkage mechanism 210 from the upright seat position 150 into the horizontal bed position 152 or vice versa are marked by dashed lines. Moreover, movement paths 422 and 424 of the linkage members 224a, 224b of the second linkage mechanism 220 are marked by dashed lines.

A first movement path 412 is associated with a movement of the first rotary joint 218a and of the at least one coupled linkage member 216a to 216d. A second movement path 414 is associated with a movement of the second rotary joint 218b and of the at least one coupled linkage member 216a to 216d. A third movement part 416 is associated with a movement of the third rotary joint 218c and of the at least one coupled linkage member 216a to 216d. A fourth movement path 418 is associated with a movement of the fourth rotary joint 218d and of the at least one coupled linkage member 216a to 216d.

A fifth movement path 422 is associated with a movement of the linkage members 224a, 224b of the second linkage member 220 with respect to the fixed rotary joint 222 from the upright seat position 150 into the reclined intermediate position 154. A sixth movement path 424 is associated with a movement of the linkage members 224a, 224b of the second linkage mechanism 220 with respect to the fixed rotary joint 222 from the upright seat position 150 into the horizontal bed position 152.

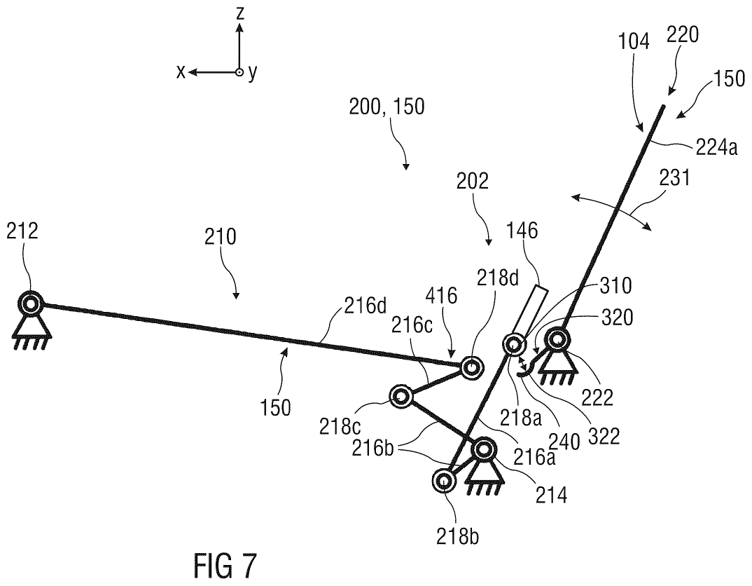

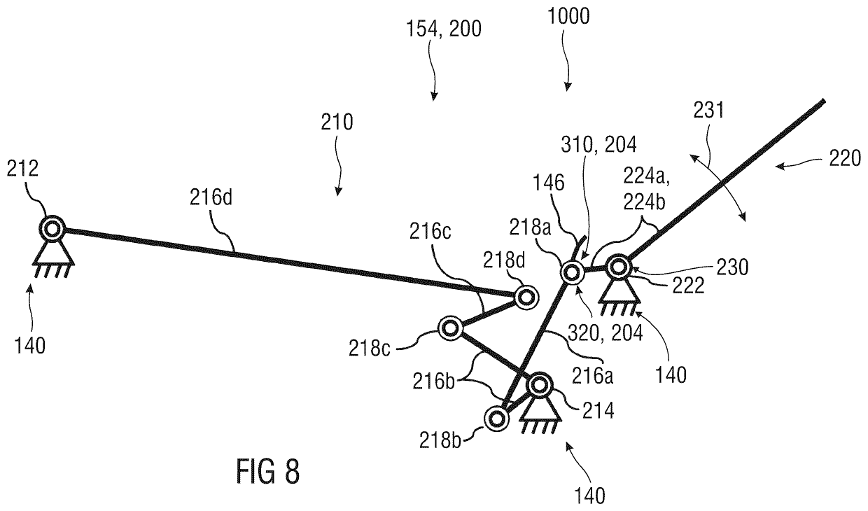

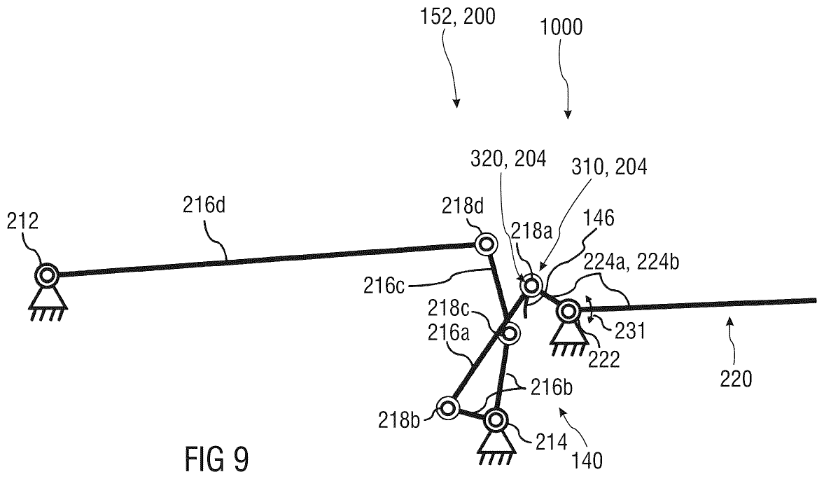

FIG. 7 shows the reclining mechanism 200 in an upright seat position 150, FIG. 8 shows the reclining mechanism 200 according to FIG. 5 in a reclined intermediate position 154, and FIG. 9 shows the reclining mechanism 200 according to FIG. 5 in a horizontal bed position 152.

The reclining mechanism 200 comprises a single drive unit 230 in order to adjust the vehicle seat 1000 from its upright seat position 150 into the horizontal bed position 152 and vice versa as per arrow 231. To successfully recline the vehicle seat 1000, it may furthermore suffice to manually actuate the seat pan 102 and/or the backrest 104 (illustrated in FIG. 1), for example to move, pull or push same, in order to fully adjust the vehicle seat 1000 from its upright seat position 150 into the horizontal bed position 152 and vice versa as per arrow 231.

The first linkage mechanism 210 comprises at least one first coupling element 310, which is guided movably in a guide element 146, which is arranged on the fixed base element 140.

The first linkage mechanism 210 comprises the linkage members 216a to 216d which are coupled together in an articulated manner, wherein the first linkage member 216a acts as a drive member. The further linkage members 216b to 216d are in the form of output members, in particular rotary bars or rotary levers.

The second linkage mechanism 220 comprises at least one second coupling element 320 having a receiving portion 322, which, in the coupled state 204, comes into contact, in particular engagement, with the first coupling element 310, as shown in FIG. 8. The coupled state 204 is adopted in the reclined intermediate position 154.

As a result of the contact or the engagement of the second coupling element 320 with the first coupling element 310, it is possible, for example, upon actuation, in particular movement, of the second linkage mechanism 220 from the reclined intermediate position 154 into the horizontal bed position 152, for a movement of the first linkage mechanism 210 to be initiated. The reclining mechanism 200 may be designed to transfer the seat support structure 130 by shifting the first coupling element 310 along the guide element 146 by moving the second coupling element 320.

For example, the linkage mechanisms 210, 220 are separated from one another in the uncoupled state 202 (illustrated in FIG. 7). In particular, the linkage mechanisms 210, 220 are completely mechanically uncoupled from one another in the uncoupled state 202. In other words: the linkage mechanisms 210, 220 are spaced apart from one another and uncoupled from one another in an unguided manner.

The reclining mechanism 200 may, in the uncoupled state 202, comprise, for example, a free running region 240 (illustrated in FIG. 7) between the first coupling element 310 and the second coupling element 320 such that the backrest 104 can be reclined from the upright seat position 150 into a reclined intermediate position 154 before the coupling elements 310, 320 come into engagement in the coupled state 204 in order to transfer the seat pan 102 and the backrest 104 into the horizontal bed position 152. The free running region 240 may define a spacing between the first coupling element 310 and the second coupling element 320, in which the two coupling elements 310, 320 may be in the uncoupled state 202.

### LIST OF REFERENCE NUMERALS

100, 1000 Seat
102 Seat pan
104 Backrest
106 Fitting device
108 Axis of rotation
110 Longitudinal adjustment device
112 Rail assembly
114 First rail element (upper rail)
116 Second rail element (lower rail)
118 Front portion
120 Rear portion
130 Seat support structure
140 Base element
142, 144 Base portion
146 Guide element
150 Position, in particular upright seat position
152 Position, in particular horizontal bed position
154 Position, in particular reclined intermediate position
200 Reclining mechanism
202 Uncoupled state
204 Coupled state
210 Linkage mechanism, in particular first linkage mechanism
212 Fixed rotary joint, in particular first fixed rotary joint
214 Fixed rotary joint, in particular second fixed rotary joint
216a to 216d Linkage member
218a to 218d Rotary joint
220 Linkage mechanism, in particular second linkage mechanism
222 Fixed rotary joint
224a to 224b Linkage member
230 Drive unit
231 Arrow
240 Free running region
310 Coupling element, in particular first coupling element
320 Coupling element, in particular second coupling element
322 Receiving portion
330 Coupling element, in particular third coupling element
332 Receiving portion
412 to 424 Movement path
α1 to α3, β1 Angle
y1, y2 Horizontal pivot axis
x Longitudinal axis
y Transverse axis
z Vertical axis

1. A vehicle seat, comprising:
a seat support structure which comprises at least a fixed base element, a seat pan and a backrest, which are adjustable relative to the base element, and
a reclining mechanism which is designed to move the seat support structure between an upright seat position and at least a horizontal bed position,
characterized in that
the reclining mechanism comprises a first linkage mechanism with which the seat pan is coupled to the base element, and a second linkage mechanism with which the backrest is coupled to the base element,
wherein the two linkage mechanisms are or have been maintained in an uncoupled state relative to one another in the upright seat position and, when the reclining mechanism is actuated, adopt a coupled state in order to transfer the seat support structure into the horizontal bed position.

2. The seat according to claim 1, characterized in that the linkage mechanisms are designed, in the coupled state, to move the seat pan and the backrest at the same time.

3. The seat according to claim 1, characterized in that the linkage mechanisms are designed, in the coupled state, to raise the seat pan about a first horizontal pivot axis and to recline the backrest about a second horizontal pivot axis, wherein the first horizontal pivot axis is different from the second horizontal pivot axis.

4. The seat according to claim 1, characterized in that the reclining mechanism is designed such that the coupled state of the linkage mechanisms is able to be established by actuation of the second linkage mechanism relative to the base element.

5. The seat according to claim 1, characterized in that the linkage mechanisms are separated from one another in the uncoupled state.

6. The seat according to claim 1, characterized in that the linkage mechanisms are completely mechanically uncoupled from one another in the uncoupled state.

7. The seat according to claim 1, characterized in that the linkage mechanisms comprise coupling elements which are spaced apart from one another in the uncoupled state and come into engagement with one another in the coupled state.

8. The seat according to claim 7, characterized in that the first linkage mechanism comprises at least one first coupling element which is guided movably in a guide element which is arranged on the fixed base element, and the second linkage mechanism comprises at least one second coupling element having a receiving portion which comes into engagement with the first coupling element in the coupled state.

9. The seat according to claim 8, characterized in that the reclining mechanism is designed to transfer the seat support structure from one position into another by shifting the first coupling element along the guide element by moving the second coupling element.

10. The seat according to claim 1, characterized in that the reclining mechanism comprises, between the linkage mechanisms, a free running region by which the backrest is able to be reclined from the upright seat position into a reclined intermediate position before the linkage mechanisms pass into the coupled state in order to transfer the seat support structure into the horizontal bed position.

11. The seat according to claim 1, characterized in that the first linkage mechanism comprises two fixed rotary joints between which a first number of relatively pivotable linkage members are arranged, wherein the fixed rotary joints couple the seat pan to the base element.

12. The seat according to claim 1, characterized in that the second linkage mechanism comprises a fixed rotary joint which couples the backrest to the base element, and a second number of pivotable linkage members which are pivotable about the fixed rotary joint.
